(19) United States
(12) Patent Application Publication
(10) Pub. No.: US 2024/0427135 A1
(43) Pub. Date: Dec. 26, 2024

(54) Unknown

(71) Applicant: John Peter Hall, Surfside, FL (US)

(72) Inventor: John Peter Hall, Surfside, FL (US)

(21) Appl. No.: 18/445,150

(22) Filed: Jun. 26, 2023

(51) Int. Cl. G02B 23/18; H04N 23/50

(52) U.S. Cl. CPC G02B 23/18; H04N 23/50

(57) ABSTRACT

This Video/Camera works in the same way as do our human eyes, with the two Lenses placed six and a half centimeters apart from the center of the left Lens to the center of the right Lens, and also, the two Lenses always focusing on the same spot. Our human eyes, when wishing to see something that is closer in distance, the eyes swerve more to the center; left eye turning right, and right eye turning left. In order to target at a point from two angles, the eyes must give less attention to the wider area. All around the area, the two human eyes see a misty, vague shadow, and also double, since the two eyes look from different locations. Each Lens has two Image Sensors—a Sensor is the receiver of the light from a Lens—quite close together in parallel, the first Sensor of the two is too close in length from the Lens in order to be clear. The first Sensor of the left Lens, and the first Sensor of the right Lens, has a small hole in its center, and that is the only light entering onto the center of the second Sensor on the left, and the second Sensor on the right.

The Lenses of Focal Point Stereoscopic Video and Camera can continue focusing on a spot of the photographer's choosing as the cylinders of the video move away.

### FIELD OF THE INVENTION

This is a new type of stereoscopic camera. The main difference between this newer version of this machine that has the lenses of the two Videos/Cameras swerving together as they focus on the same spot, is that only the small dot in the center of the screen is clear, and 3-D, and everything else that is seen around the wide screen is out of focus and doubled. There are no 3-D eyeglasses required while watching the part(s) of the film that had the Focal Point Stereoscopic in use. The time in the film where in this Video is in use, all the audience will see through the eyes of the actress, actor, or any animal that has its two eyes formed enough together in the forward position to give depth perception.

### BACKGROUND OF THE INVENTION

Throughout the history of 3-D Movies, when entering the theatre, we all need to put on the glasses to see 3-D. Out of curiosity, we all removed our glasses to see the difference. It was there for all, two of everything, and not so clear. The two projectors and their lenses seem to be placed in parallel; that is why you see double without the glasses. There is some difference in the filtering between the two lenses, and the necessary completion through the glasses: left side, no red; right side, no green; or horizontal on one and vertical on the other-whatever is the way in which these machines work. When looking at the screen of some 3-D movies videoed more recently, the observation without the glasses shows less separation from left to right, and not as much out of focus as compared to 3-D movies filmed on year 2005. This may be from the use of videos that swerve together and able to focus on the same spot.

‘Focal Point Stereoscopic Video and Camera’ is very different than those from which we are familiar. Not only do the lenses of these two Videos/Cameras work as do others—their lenses swerving to focus together on the center—but each lens has two Image Sensors in series, that receive the light from the lens. In this discussion of the Sensors used in U.S. Pat. No. 18,445,150, “the first Sensor” is the one of the two Sensors that receives light from the lens before “the second Sensor” in that series. The first Sensor from each lens is too close by length from the lens in order to focus light clearly. The second Sensor from each lens is at the correct length from the lens in order to receiver light clearly. The first Sensor of the left lens has a small hole in its center, and the light traveling through that small hole alone arrives to the center of the second Sensor of the left lens, and the first Sensor of the right lens has a small hole in its center, and the light traveling through that small hole alone arrives to the center of the second Sensor of the right lens.

As light arrives through a lens, the rainbow of colors separate-red the slow, violet the fast—and within all videos and cameras have extra lenses within to bring the colors back to white. I do not work in a Camera company, but I am wagering that the very center of the lens has no waver, it maintains all white. The only concern of IS1B, and IS2B, is their final, out of focus result—the items off to the side, are they a slightly different color? Testing will learn the need of some extra lenses within the Videos and Cameras, or not.

These videos work as do our own human eyes: When looking afar, our eyes are almost parallel; when looking close-up, our eyes turn toward themselves to focus on the same spot. For ex.: You are in the city and in need of the time, your eyes focus on your own watch. And then, when focusing on a beautiful car across the street, and pointing at it, you see two first fingers. We often observe that fact when having a discussion with someone close at hand, and say “You are far away”, as a figure of speech, but also the truth of the other person's paralleled pupils.

There are a number of machines that have the two lenses which swerve together in order to focus on the same spot. The unique, and great difference between any previous 3-D Video/Camera—the Lenses of which swerve together—and the ‘Focal Point Stereoscopic Video and Camera’, is that while watching the screen during the time when Focal Point Stereoscopic Video and Camera is in use, no eyeglasses are in use.

This Machine has also a Trademark: ‘A Human Point of View’, because it does the exact same thing as do human eyes. Its two converging lenses are placed (example 6.5 cm) apart from the center of one lens to the center of the other lens, so that these two lenses are working from the same location as are humans' pupils. There is a possibility that the mechanism required in making this ‘Focal Point Stereoscopic Video and Camera’ usable, it may need for the lenses to be wider apart than the numbers mentioned in these Figures, but only from trial and tuning will the blueprint be drawn out.

The name lens is just an amounting part, an angle of a sphere of glass.

“In year 1981, Sony unveiled the first consumer camera to use a charge-coupled device for imaging, eliminating the need for film: the Sony Mavica. While the Mavica saved images to disk, the images were displayed on television, and the camera was not fully digital. In year 1991, Kodak unveiled the DCS100, the first commercially available digital single-lens reflex (DSLR) camera” (Wikipedia).

No longer does light from the lens cross path to land on the plate as a mirror,
but right at that point of crossing, where all the lights are close together, they are captured on an ‘Image Sensor’. As an Image Sensor of a camera receives light from a lens, the lens itself must be perfect in order for the light to arrive at a small dot, for only then can the disc hold those thousands of pictures. An understandable number of camera companies have themselves bonding together with one of the smaller number of lens masters.

Several photographers of a Mirrorless camera have a viewfinder, the carrier by which is electronic. It was written that in the year 2010, the visuality of the viewfinder of the Mirrorless camera was one twentieth of the viewfinder of the DSLR, because of the DSLR's light arriving by laser. In less than eight years, in 2018 the viewfinder of the Mirrorless camera had then risen much greater than 50% of the DSLR's viewfinder.

The main issue of discussion in this new Patent Pending, and the part claiming its uniqueness, is the concentration to the center of an object by two different lenses as they focus to the same spot, with the center of each Image Sensor being clear, and the area just out of the center being out of focus. When the four Image Sensors are bonded together, the centers of the two backside Image Sensors are one and the same, and all around the screen of the motion picture is out of focus and doubled. 9L and 9R are the two lenses that are the first receivers of light. Not only are 9L and 9R focusing together, but upon pushing button 67, Sphere 1, that holds lens 9L, is no longer locked in the center of Lens 1; and Sphere 2, that holds lens 9R, is no longer locked in the center of Lens 2, with lens 9L and lens 9R continuing to focus on their present spot as the Cylinders Lens 1 and Lens 2 begin to swerve away; behaving similar to our eyes staying focused, as our head moves away. Now there are different ways of travel for/of the Video: Commonly seen as a demonstration of a movie, is the track for the Video as it is moving in one direction, or the other. The wheels on the track can tell the computer its change of distance from the lenses to the object.

### DETAIL DESCRIPTION OF THE INVENTION

All the illustrations, drawings and descriptions presented within this Embodiment are for the purpose of describing selected versions of the present invention and are not intended to limit the scope of the present invention. Several parts of the descriptions may even seem so simple to any user of a camera, but these basics need to be said in order to describe the difference between this new product in comparison with presently used videos or cameras.

The diameter of the lens that receives the light into the video/camera, is determined by the size of the video/camera; the diameter of the lens of my Cell Phone is 0.6 cm. On the other league is the zoomable lens of a Paparazzi's camera.

In a camera, its cylindrical extension out from the front wall of the camera, with a lens at its end, is all together called a Lens. Of the basic cameras, their ability to remove the Lens of the camera, and replace it with a Lens made for a different function-zooming from afar; for wide angle (‘fisheye’); for close-up; or regular in its function. To my knowledge, the Lens of a camera is basically of two types: Extendable and Retractable; or Rigid: Of the former title, a zooming lens, and a ‘point-and-shoot’ (those small cameras, the Lens of which detracts when not in use, for sliding into pocket); Of the latter title, the length outside of the Lens (the cylinder)—from the entrance of light within it, until the entrance of light into the camera—is rigid, and therefore, the requirement of having lenses inside the cylinder that can slide from within.

As presented in diagrams within this pending patent, Lens 1 is the left hand of the photographer when the Video/Camera is in use, and Lens 2 is the right hand of the photographer when the Video/Camera is in use.

The forward end of Focal Point Stereoscopic Video and Camera is in reference to the entrance of light from outside through the lens 9L of Lens 1, and the entrance of light from outside through the lens 9R of Lens 2. Approximately 2.8 cm aft of lens 9L, is the fulcrum from which Lens 1 can swivel left and right, and 2.8 cm aft of lens 9R, is the fulcrum from which Lens 2 can swivel left and right. Lens 1 and Lens 2 are cylinders, and so, a fulcrum on the top, and a fulcrum on the bottom of each cylinder. The four fulcrums are 8L and 4L, located aft of 9L, outside of

Lens 1, and 8R and 4R, located aft of 9R, outside of Lens 2 (FIG. 3 & FIG. 4). Fulcrums 8L, 4L, 8R, 4R are not nuts, but solid upright hinges, or some other junction, that allows Lens 1 and Lens 2 to swivel. Sphere 1A is bolted at its back end to Lens 1, and Sphere 2A is bolted at its back end to Lens 2. The small back ends of Sphere 1A and Sphere 2A are simply outside skins of Lens 1 and Lens 2.

Fulcrum 8L has beam 22L that rides straight backward, fulcrum 4L has beam 23L that rides straight backward, fulcrum 8R has beam 22R, that rides straight backward, and fulcrum 4R has beam 23R that rides straight backward. At their ending, all the four beams 22L, 23L, 22R, and 23R turn 90 degrees inward, as Lens 1 and Lens 2 continue, showing their greater length than the beams. Now, beam 22L bonds with beam 22 which bonds to beam 22R; beam 23L bonds with beam 23 which bonds to beam 23R. Beam 22 and beam 23 are horizontally connected to 30. (FIG. 1)

30 is the skin of Lateral Movement Mechanism (LMM) 26 (FIG. 5), that is used to focus these “human eyes”—9L and 9R—far or near. On the top of 26, there is a Handwheel 27 that is placed horizontally above 26. On several Figures, 27 is presented having less than two inches in diameter, and during the demo, 27 may require a wider diameter. On the outside diameter of 27, is 28, the post rising 90 degrees upward for the fast turning of 27. At the location of 27, at its center, is the top of post 35, that drops down through 30, the outside case of LMM 26. Inside 30 is the bonding of 35 to the top bevel gear 31. On the bottom of 26 is bevel gear 34, which uses post 36 to stable on 30.27 turns clockwise, or counter-clockwise, which guides 26—the transmission of Lens 1 and Lens 2—that makes the left lens, 9L, and the right lens, 9R, always in focus together at the same spot; closer in distance—the upper lip of a person's face, or farther apart, the roof of a building half of a mile away.

FIG. 5 has you behaving as the model—not as the director—which has your eyes following with the light upon entering the lenses, and therefore, left bevel gear 32 is on your right; right bevel gear 33 is on your left; with top bevel gear 31 and bottom bevel gear 34 shown as their names say. The bonding of bevel gear 32 is gear axle 39; the bonding of bevel gear 33 is gear axle 40; the bonding of bevel gear 34 is gear axle 36. Gear axle 39 and gear axle 40 are cylinders that are smooth
on their outside. On the inside of cylinder 39 is threaded hole 37. On the inside of cylinder 40 is threaded hole 38. These threaded holes work as long nuts for guiding 6 of 33 the bolts used outside. Bolt 42L, and bolt 42R, as seen on their extension outside of their cylinders 39 and 40, become rod 43L and 43R. Rod 43L and rod 43R end shortly at post 50L, and post 50R. These two posts, 50L and 50R, are there far before the arrival to the top center of Lens 1 and the top center of Lens 2, because the forward ends of Lens 1 and Lens 2 are held by bolt 4L, bolt 4R, bolt 8L and bolt 8R, which makes Lens 1 and Lens 2 to move their back ends strictly in a circular fashion. Covers 47 and 48 both have indent 49 underneath, side to side, working as aisles for post 50L and post 50R, used for keeping the rods 43L and 43R to continue to move straight out, left and right. From post 50L and post 50R begin rod 41L, and rod 41R, which arrive at the top of Lens 1, and the top of Lens 2, at bolts 55L and 55R. Bolt 55L and bolt 55R are the fastening of the extending and retracting rods 41L and 41R. Lens 1 and Lens 2 are bolted by not only their backward, top bolts, but also, a continuation by rods from bolt 55L and bolt 55R to the outside bolt 56L of Lens 1 and the outside bolt 56R of Lens 2. Bolt 56L is stationed 90 degrees to the outside from top center bolt 55L, and bolt 56R is stationed 90 degrees to the outside from top center bolt 55R. The continuation outward of 41L and 41R, is rod 45L, rod 45R, rod 44L, and rod 44R, rod 46L, and rod 46R. Rod 46L ends at bolt 56L, and rod 46R ends at bolt 56R. With Lens 1 bolted at its forward end by 4L and 8L.

LCD 80, and Eyecup 82, are seen from FIG. 1, FIG. 2, FIG. 3 and FIG. 4. As Lens 1 and Lens 2 are focusing, the very center of Image Sensor 1A, and the very center of Image Sensor 2A, are identical to each other. A very short distance ahead of the arrival of light to the Image Sensor (IS) 1A, is Image Sensor (IS) 1B (FIG. 6). Likewise, a very short distance ahead of the arrival of light to the IS2A, is IS2B. Both IS1B in Lens 1, and IS2B in Lens 2, have a small hole 13L, 13R in their center (FIG. 7), and those two small holes alone allow light to land onto the center of IS1A, and onto the center of IS2A. IS1A is at the perfect distance from 9L, and IS2A is at the perfect distance from 9R, for their clear focusing. Because of the shorter distance of IS1B from 9L, and because of the shorter distance of IS2B from 9R, the Images of Sensor
1B and Images of Sensor 2B are out of focus, and when laid on the screen together, Sensor 1B and Sensor 2B are separate. My older Cell phone had only one lens, and when using it as a Camera, or Video, there is no focusing required, and I imagine that is done to there being a very small Aperture. In order to make 1A-1B and 2A-2B different in their clarity, it may help to have Aperture wider in diameter, and also Sensor 1B and Sensor 2B having much less pixels or dots, right at the outset, and soon away from the center, much less pixels and dots. As we look around with our own eyes, we can focus close, and far, in a glance, and so will be the constant use of Handwheel 28. Upon seeing something attentive, Handwheel 27 is in use for fine tuning, and then the pushing of button 67.

As 28, and 27 are used, and the displays shown by Liquid-crystal display (LCD) 80, or eyecup 82 (FIG. 1), for turning clarity, an electrical wire is connected to the focusing of lens from either gear 42, screwing outside or inside of the machine (FIG. 5), or a connecting wire from 27, for connected to the computer in 73L and the computer in 73R (FIG. 9). Common Videos and Cameras can extend the lens forward while focusing on items closer in distance. Since lenses 9L and 9R cannot extend farther forward, in order to receive the correct depth, the Image Sensors must depart, in order to keep focused on the same angle of light through the lenses 9L and 9R. This is done by having IS1A located inside cylinder 10a, that is smaller in diameter than the forward cylinder 10b; the forward center of 10b holds 9L (FIG. 9). And by having IS2A located inside cylinder 11a, that is smaller in diameter than the forward cylinder 11b; the forward center 11b holds 9R. Cylinder 10a and cylinder 11a are made to slide away from and slide further in to 10b and 11b. On the back, outward part of 10a is transmission 70L, and on the back, outward part of 11a is transmission 70R. 73L and 73R are each a computer that receives turnings from the mechanical motions above, and they tell transmissions 70L and 70R to work accordingly. Transmission 70L has rod 77a on the left side, and has rod 77b on the right side, at the ending of which are left wheel 71a and right wheel 71b.

Transmission 70R has rod 78a on the left side, and has rod 78b on the right side, at the end of which are left wheel 72a and right wheel 72b. Outside and extending back of 10b are left side elongated flat 75a and right side elongated flat 75b (FIG. 9). The wheels 71a and 71b at the top of 10a that are connected with the flat 75a, and flat 75b, are the way from which cylinder 10a slides in and out of cylinder 10b, for constant clarity in the center from 9L. The wheels 72a and 72b at the top of 11a that are connected with the flat 76a, and flat 76b, are the way from which cylinder 11a slides in and out cylinder 11b, for constant clarity in the center from 9R. Only by testing will it be learned to make the appropriate distance between IS1A˜IS1B, and the distance between IS2A˜IS2B. The diameter of the two small holes in the center of IS1B and IS2B can be, need be, very small, for the fact that the center of Lens 1 and the center of Lens 2 are focused at the exact same spot.

There is also the thought of the needed aperture as the entrance of light before IS1B, and an aperture as the entrance of light before IS2B, as needed in any photography.

The farther away from the center of the screen of 1B to its outer diameter, and the farther away from the center of the screen of 2B to its outer diameter, shows the smaller number of pixels, just like human eyes. At the presentation, we spoke of the requirement of very good lenses, but that good lens is only truly needed in the center of 9L and the center of 9R.

Though only the very center of 9L and the very center of 9R are clear, under this settlement, the larger area of Lens 1 and the larger area of Lens 2 are not allowed to spread out as a rainbow of colors, only out of focus, and double, and therefore, the possibility of add-ons of lenses may be required. And yes, I have been concluding that the light in the very center of Lens 1, and Lens 2, need not be diverted back to their white light. Any necessary lenses for IS1B, and IS2B, will have a small hole in their center to not interrupt clear light to the center of IS1A, and IS2A.

Within the “Background Of The Invention”, it is described that Sphere 1 and Sphere 2—from which are held the lens 9L in the center of Sphere 1, and the lens 9R in the center of Sphere 2—can be separated from Sphere 1A and Sphere 2A by the pushing of button No. 67.

Our eyes are made of an entirely different element than glass, and though we see clearly only in that small dot in the center of our area, at the same time, together our eyes can see on a wide area on the side of 160, and movements of 180 degrees wide. In order to call this machine ‘human’, the screen must be wide enough to behave as though the audience is looking through the eyes of a person.

During the 1950's and 1960′, there were a certain number of very wider screens on the cinema. The greatest in that regard was “Cinerama”: “In the Cinerama, the video in the center is looking straight ahead; The video on the left of center is looking to the right; The video on the right of center is looking left. The final result is the Cinerama's 146 degrees angles of ‘vision’”—(Wikipedia).

There are Wide Angle Lenses; Super Widescreen, and the “Samyang 14 mm Ultra-Wide-Angle Lenses f/2.8 IF ED UMC Lens for Canon gives you approximately a 115-degree view with dramatic results when used with a full frame digital camera or 35 mm film camera”—(Wikipedia).

When watching a Cinerama, the audience can look all around the wide screen and see all the people. At the time in a movie where in A Human Point Of View is in use, only the very center is clear, all around the screen is vague and doubled. The audience is looking through the eyes of one actress, or actor, and focusing only on that clear, 3-D spot, and then knowing exactly to what that person is truly giving attention, and the audience wishing to be a psychologist for the behavior of that person. There are certain factors in the area around the clear center that are required: an item that is 40 degrees off to each side of the clear center of the lens, its light arriving from that side may not be bent at an angle—the light post on the street, the straight up palm tree—it must be visible off to the side straight up, with no curving lines. In year 2009, there began the beginning of wider TVs, wider computer screens and other digital displays. Original TVs used glass for their curve screen, and light reflects 12.5 degrees entering into glass, and 12.5 departing glass, giving TVs 25 degrees on the screen. I know not how the light is transferred on to the flat screens now; sent electronically, possibly.

With the much wider lenses now available in year 2020, the Focal Point Stereoscopic Video and Camera may be able to do the Video/Camera with only two Lenses, since there is the consideration that only the clear, 3-D visuality in the very center of the screen has the audience giving attention in that spot, with the audience seeing vague movements of over 50 degrees on the left side of the clear center, and 50 degrees on the right side of the clear center.

By giving this machine the name “A Human Point Of View”, the width of the one lens used by ‘Ultra Wide-Angle’ of 115-Degrees is more than sufficient, and 100 may be enough.

The Focal Point Stereoscopic Video and Camera has no need for the three videos to work as “synchronized cameras”. Outside of the clear dot in the center of the ‘A Human Point of View’, the screen is fuzzy, and double all around the clear, center dot. Human eyes are never clear on their side, and all that gives attention on the sides is a change of movement, or a color, that draws curiosity, and hence, for the eyes to turn to see that notice. This “A Human Point Of View” is an exhibit of seeing through someone else's eyes. Human eyelids are not rectangular, but rather elliptical, with their outside edges not swerve, but to an angular point. Lengthening the width of 9L, and lengthening the width of 9R, here is presented from left to right:

At the forward end of Lens 1 is placed Sphere 1. Lens 1 is located inside of Sphere 1. At the forward end of Lens 2 is placed Sphere 2. Lens 2 is located inside of Sphere 2. Here, as a Video, 9L is bolted in the center of Sphere 1, and 9R is bolted in the center of Sphere 2. The use of the Video in Focal Point Stereoscopic Video and Camera begins with the photographer wandering around the area on the screen, handwheel 27 is used for relocating the focus from far to near, or near to far, just the center. As shown in FIG. 5, wheel 27 turns Lens 1 and Lens 2 in unison. When something deserves attention, the video is turned to place that item in the center of the screen. Handwheel 27 is turned, for the final focusing of the center, and then button 67 is pushes. The mechanical turning of 27 is not only for the photographer's relocation from far to near, but by its turning, the computer knows the exact length from lens to ‘model’. Sphere 1 is inside of Sphere 1A. Sphere 1A is bolted to the back side of Lens 1. Button 67 releases Sphere 1 from its holding of Sphere 1A. Likewise, Sphere 2 is inside of Sphere 2A. Sphere 2A is bolted to the back side of Lens 2, and button 67 releases Sphere 2 from its holding of Sphere 2A.

Now that Sphere 1 and 9L are free, and Sphere 2 and 9R are free, the ‘model’ stays in the center of the screen, as the Video turns direction, and the nose moves at its own speed to the “model”. On the inside of Sphere 1, between Sphere 1 and Lens are: 65Li on the left, 65Lii on the right, laid horizontally in the center by height in the front of Lens 1, with 65Li and 65Lii being bolted to Lens 1 with their gears connected to Sphere 1 for yaw axis, and together are 66Li on the top, and 66Lii on the bottom, in the center by width in the front of Lens 1, with 66Li and 66Lii being bolted to Lens 1 with their gears connected to Sphere 1 for pitch axis (FIG. 10). And on the inside of Sphere 2, between Sphere 2 and Lens 2 are: 65Ri on the left, 65Rii on the right, laid horizontally in the center by height in the front of Lens 2, with 65Ri and 65Rii being bolted to Lens 2 with their gears connected to Sphere 2 for yaw axis. With other circular gears, 66Ri on the top, and 66Rii on the bottom, laid in the center by width in the front of Lens 2, with 66Ri and 66Lii being bolted to Lens 2 with their gears connected to Sphere 2 for pitch axis.

As Lens 1 and Lens 2 are moving away from an area, and 9L and 9R continue their focus in the center of the screen, depending on the direction of Lens 1 and Lens 2, the screen shows the nose rising closer to the center of the screen of either 9L, or 9R. There is the thought of different type noses on this Video, for the undeniable different curve: Arabian nose; Asian nose; African nose, etc. in response to the Actress/Actor being portrayed. Or if the head is turning down as the eyes stay focused, both eyebrow rising down to be seen in both 9L and 9R. There is little to be seen from below the eyes as the head rises upward. Both of these outside covers, Sphere 1A and Sphere 2A, are stable as Sphere 1 and Sphere 2 deviate from within.

As standing still, our human eyes swivel around within their own sockets, clearly for at least 50 degrees in any direction. As 9L and 9R are focusing together, they must continue to focus on that very spot as the Video—by feet or by wheels—swerves by side or height. The wheels used for rotating Sphere 1 and Sphere 2-65Ls, 65Rs, 66Ls & 66Rs—are located at the forward end of Lens 1 and Lens 2, and they are one of the factors involved in maximizing the swerving of the video's lenses from the center of the cylinder to its maximum angle to either side. FIG. 10 shows 9L's swivel on Sphere 1A of 32 Degrees in all directions. These are my calculations, and the camera and lens masters will be doing their own machinery.

Throughout this time when Focal Point Stereoscopic Video and Camera is in use, the user of the video will be going through the motions that were written down by the Director, because this is the whole purpose of this “A Human Point Of View”: During these moments of time, each person in the audience is in the mind of the actress/actor, and we all will be keeping our eyes focused on the center of the screen in order to know what is giving attention, and not just of where that person is looking, but truly calculating, knowing exactly at upon what that person is focusing.

During this script, we in the audience will know the Psychology of the person being portrayed. The pupils of our eyes do not so quickly change from light to dark, but we can focus from far to near at a glance. The photographer will need to be zipping around quickly and focusing, if there is the desire to make the screen look as it is whenever we turn our head around in order to see something at that moment.

The Sphere 1 of Lens 1 and the Sphere 2 of Lens 2 must be made of a substance that does not allow light to travel through them, outside of 9L, and 9R.

The Image Sensors of different depths from the Lenses as shown in Focal Point Stereoscopic Video and Camera are unique.

The curve of change of the length from the Lens to the Image Sensor might require a change of gear in the Lateral Movement Mechanism 26 than as displayed here, on FIG. 5. Possibly with bevel gear 31 and bevel gear 34 becoming of smaller diameter, than bevel gear 32 and bevel gear 33, and then with the greater number of turns of wheel pin 28 per rev of Lens 1 and Lens 2 turning out and in. However, testing will tell the best ratio to be made.

For smooth bonding of the gears within gear enclosure 30, there is a layer of ball bearings between the bevel gears and the inside of their enclosure 30, for the least resistance and longevity in the constant flow of the Lateral Movement Mechanism 26. Bevel gear 31 has ball bearing 51 between it and enclosure 30; bevel gear 32 has ball bearing 52 between it and enclosure 30; bevel gear 33 has ball bearing 53 between it and enclosure 30; bevel gear 34 has ball bearing 54 between it and enclosure 30. Bevel gears are an outer diameter of their gear axles,
and the ball bearings are between the bevel gears alone—not their gear axles—and the inside wall of enclosure 30. These ball bearings are presented as an example, for a Chemist can replace the ball bearings with a smooth, sliding coat that is of the same longevity. The top of wheel 27 shows wheel pin 28, for use when one needs to turn from far observation to near observation, or vice versa, in short order.

We have seen on movies in the theatre and on TV, times when location of an area is changed gently from the first location, or time, to the second location or time, and both locations are seen together on the screen. That is how this will easily work, with the presentation of Image Sensor 1A, Image Sensor 1B, Image Sensor 2A, and Image Sensor 2B all seen together, the center of Image Sensor 1A and the center of Image Sensor 2A are one and the same. The hole in the center of 1B, and the hole in the center of 2B must be as small in their diameter as will work, because the two lenses are seven centimeters apart from the center of one lens to the center of the other lens, and that the greater the diameter of hole 1B and the greater the diameter of hole 2B, the fuzzier can become the center of Image Sensor 1A and Image Sensor 2A—our whole reason in making “A Human Point of View”.

There may be a number of ways mechanically, electrically, computer wise to arrive at this clever use of its center point of view of two Image Sensors, and of the small number of ways that are shone in this presentation, they are only examples, and any other different variations that are presented, and that end up at this same unique final product—a focused center point of two Image Sensor—are only branches of this scope.

The final product of Focal Point Stereoscopic Video and Camera is the center of the Image Center alone to be clear and sharp, and all around the center of the page Image Sensor to be not clear, and double. When looking through our own eyes at the moon, we focus on some part of that smiling “face” of the moon; the light and shade of a leaf; the first syllable of a written word—

### ‘A Human Point of View’.

### BRIEF DESCRIPTION OF THE DRAWINGS

FIG. 1 is a perspective view of the present invention.

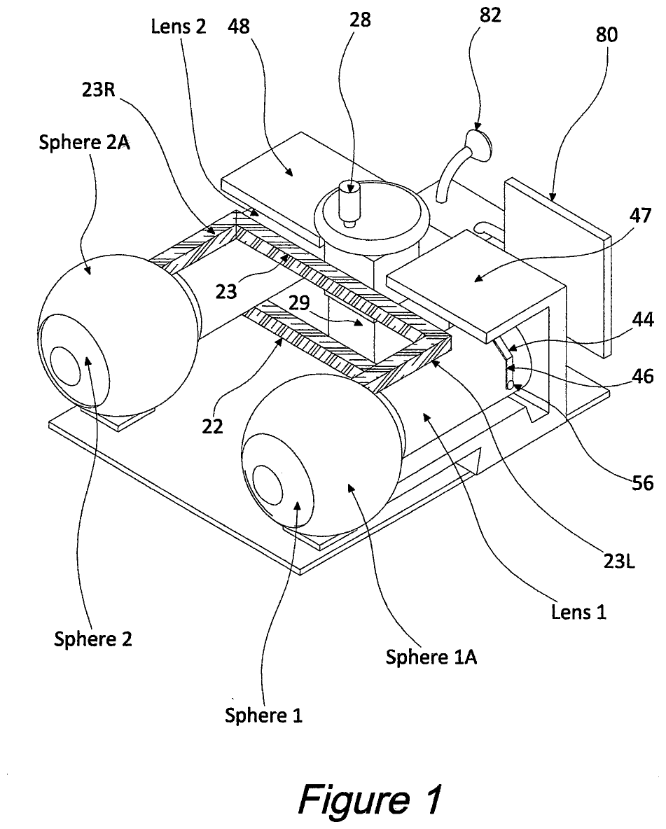

FIG. 2 is a side view of the present invention.

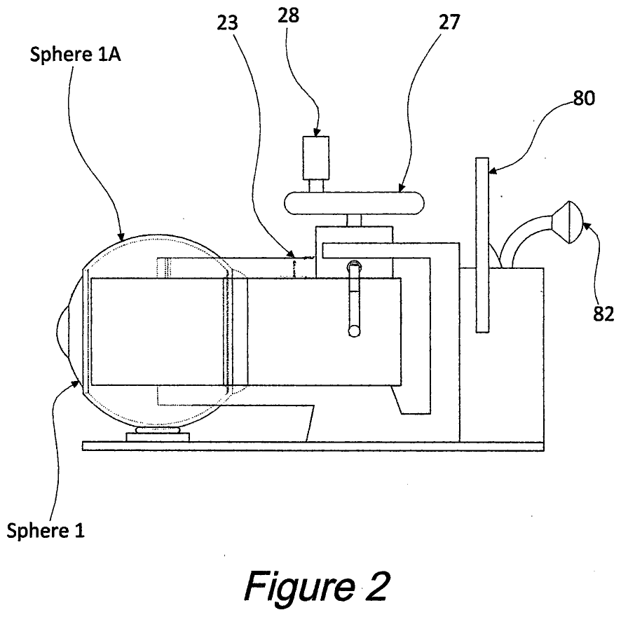

FIG. 3 is a top view of the present invention, wherein Lens L and Lens R are looking far away.

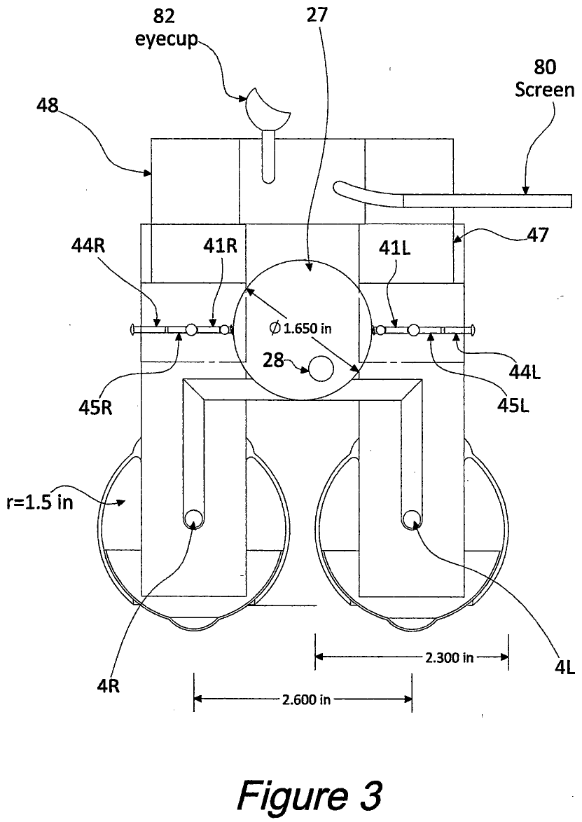

FIG. 4 is a top view of the present invention, wherein Lens L and Lens R are looking together at some item closer in distance to them.

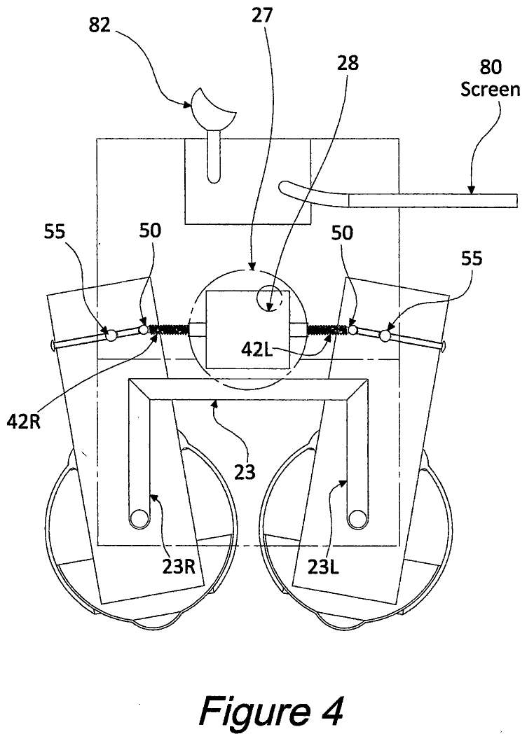

FIG. 5 is an inside view of the Lateral Movement Mechanism 26.

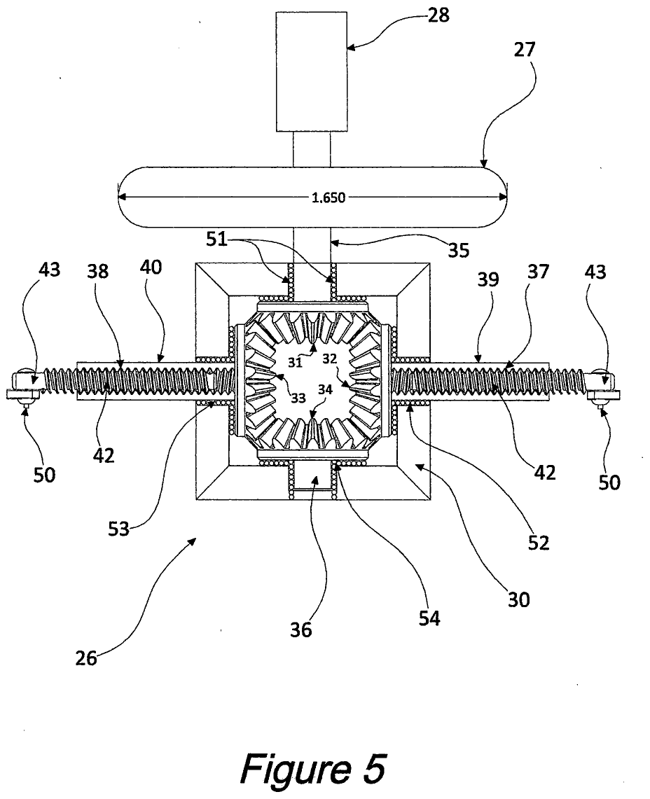

FIG. 6 is a side view of light arriving from Lens L to Image Sensor 1B and Image Sensor 1A.

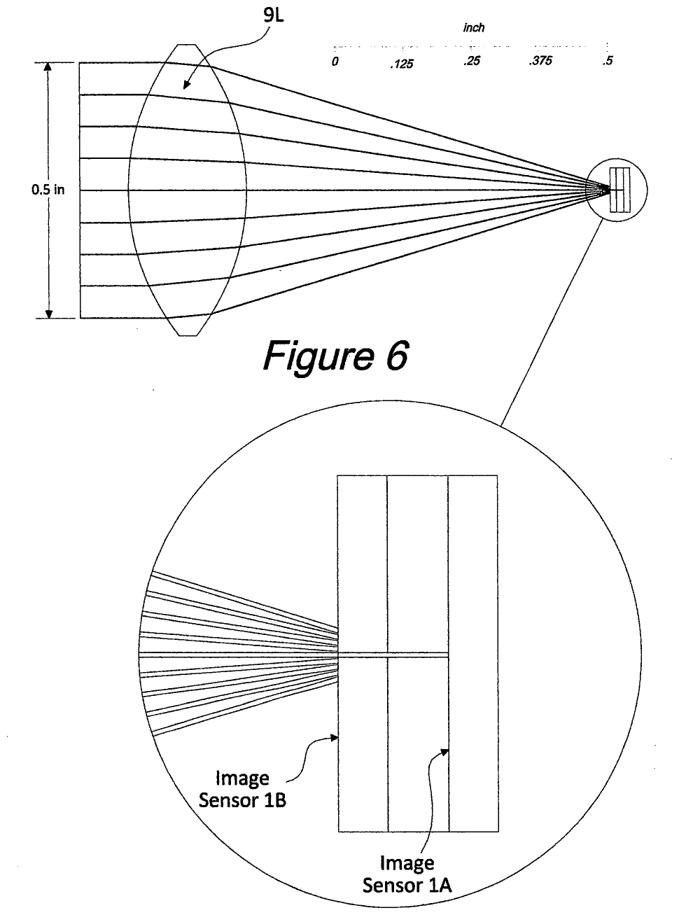

FIG. 7 is a front view of Image Sensor 1B, showing the small hole in its center.

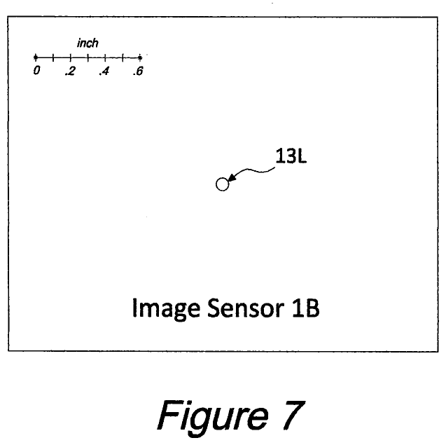

FIG. 8 is a bottom view of Cover 47 showing Aisle 49, which gives Bolt 42 and Rod 43 the ability to extend and retract.

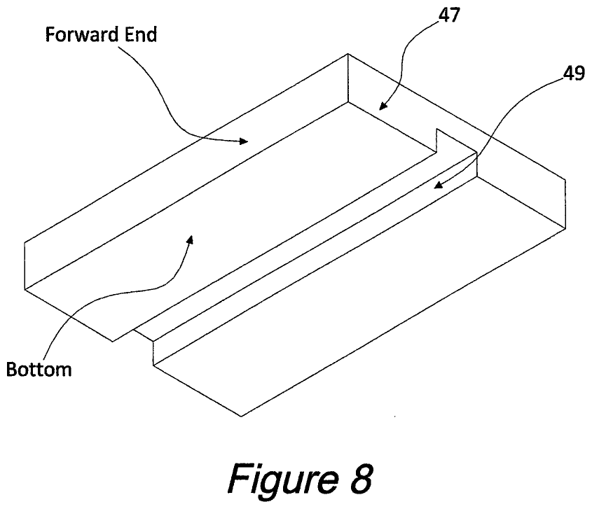

FIG. 9 is a display of the focusing of lens 9L, with cylinder 10b and 9L, and cylinder 10a that has Image Sensor (IS) 1A and IS1B, and the wheels 71a & 71b that guide the distance from 10a to 10b by computer of 27, or Lateral Movement Mechanism, from electrical wire.

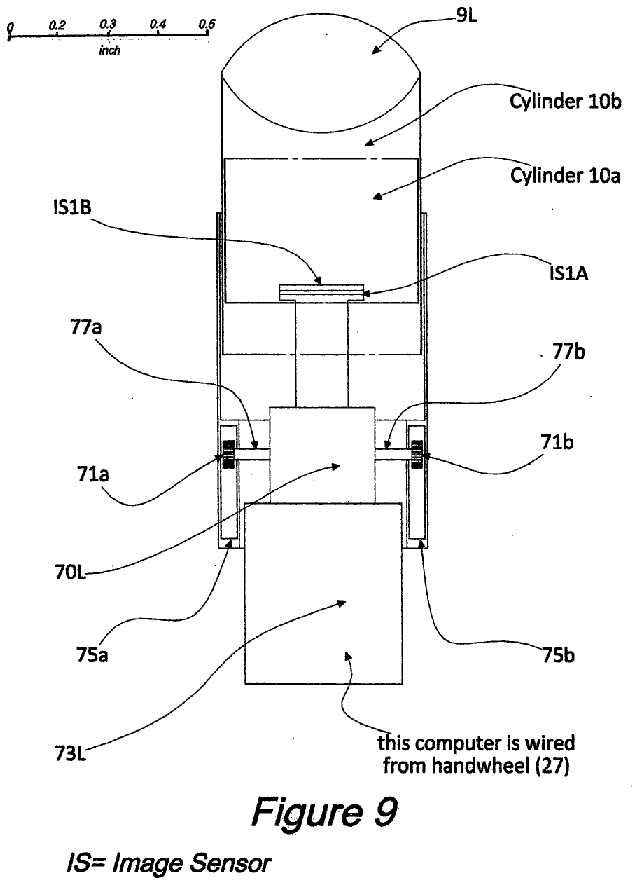

FIG. 10 is the 3D Video Lens 1 focusing by 65Li, 65Lii, 66Li, 66Lii that are bolted to the forward end of Lens 1 with wheels for guiding Sphere 1.

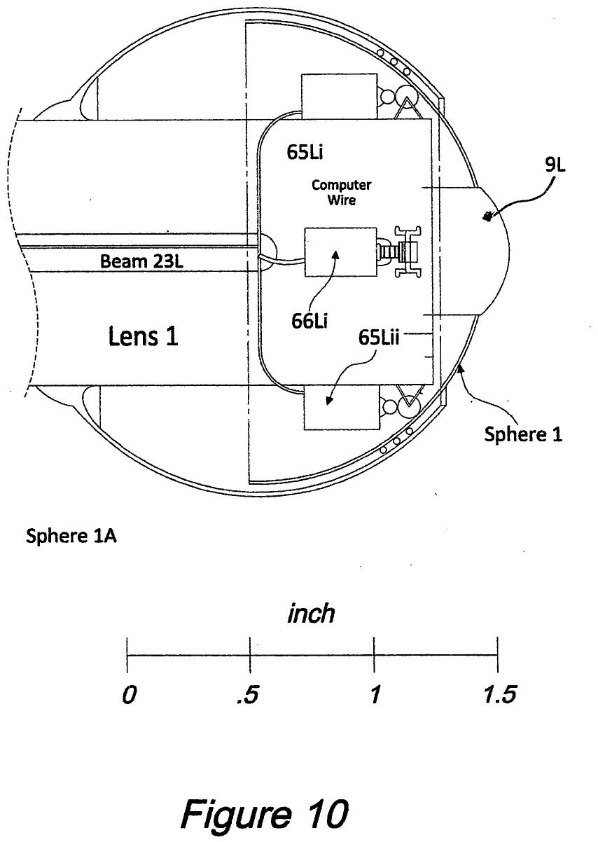

What is claimed is:

1. A Human Point of View comprises,
a lateral movement mechanism;
a left telescopic tube;
a right telescopic tube;
a ridged high beam left;
a ridged high beam right;
a ridged low beam left;
a ridged low beam right;
a left mirrorless video/camera with electronic viewfinder;
a right mirrorless video/camera with electronic viewfinder;
a left fixed pivoting post forward;
a right fixed pivoting post forward;
a left shutter;
a right shutter;
one left lens;
one right lens;
one left image sensor out of focus;
one right image sensor out of focus;
one left image sensor, its center in focus; and
one right image sensor, its center in focus.

2. The A Human Point Of View as claimed in claim 1 comprises,
said lateral movement mechanism comprises a hand wheel, a wheel pin, a mechanism base, a gear enclosure, a top bevel gear, a left bevel gear, a right bevel gear, a bottom bevel gear, a top gear axle, a left gear axle, a right gear axle, a bottom gear axle, a left extension rod, a right extension rod, a left brace, and a right brace;
said left gear axle and said right gear axle each comprise a threaded hole;
said left extension rod and said right extension rod each comprise a threaded portion; and
said left brace and said right brace each comprise a top end and a lateral end of the left telescopic tubes and a top end and a lateral end of the right telescopic tube.

3. The A Human Point Of View as claimed in claim 1 comprises,
said lateral movement mechanism base being connected normally to said beams to said left telescopic tube;
said lateral movement mechanism base being connected normally to said beams to said right telescopic tube;
said gear enclosure being connected to said mechanism base aft of said lower beams and said upper beams;
said hand wheel positioned above said gear enclosure opposite to said mechanism base; and
said wheel pin being rotatably connected atop said hand wheel.

4. The A Human Point Of View as claimed in claim 2 comprises,
said top bevel gear, said bottom bevel gear, said left bevel gear, and said right bevel gear being located within said gear enclosure;
said left bevel gear being perpendicularly engaged to said top bevel gear;
said right bevel gear being perpendicularly engaged to said top bevel gear opposite of said left bevel gear;
said bottom bevel gear being perpendicularly engaged to both said left bevel gear and said right bevel gear opposite to said top bevel gear;
said bottom bevel gear being rotatably connected to said gear enclosure by said bottom gear axle adjacent to said mechanism base;
said top gear axle traversing through said gear enclosure in order to concentrically connect to said top bevel gear to said hand wheel;
said left gear axle traversing through said gear enclosure in order to concentrically connect to said left bevel gear;
said right gear axle traversing through said gear enclosure in order to concentrically connect to said right bevel gear;
said threaded hole of said left gear axle being positioned opposite of said left bevel gear; and
said threaded hole of said right gear axle being positioned opposite of said right bevel gear.

5. The A Human Point Of View as claimed in claim 1 comprises,
said ridged low beam aft, from pivot of left Lens to lateral movement mechanism;
said ridged low beam aft, from pivot of right Lens to lateral movement mechanism;
said ridged high beam aft, from pivot of left Lens to lateral movement mechanism;
said ridged high beam aft, from pivot of right Lens to lateral movement mechanism.

6. The A Human Point Of View as claimed in claim 1 comprises,
said left mirrorless camera; and
said left electronic viewfinder;
said one eyepiece showing left lenses and right lenses together.

7. The A Human Point Of View as claimed in claim 1, also comprises,
said right mirrorless camera;
said one electronic viewfinder.
